(19) United States
(12) Patent Application Publication
(10) Pub. No.: US 2009/0169308 A1
(43) Pub. Date: Jul. 2, 2009

(54) HANDHELD MULTIPURPOSE DEVICE AND METHODS USED FOR COMMUNICATION, STABILIZATION, POSITION CONTROL, SELF-DEFENSE AND ENVIRONMENTAL PROTECTION WHILE IN, OR UNDER, WATER

(76) Inventor: Christopher Anthony Pajas, Bella Vista, AR (US)

Correspondence Address: Christopher A. Pajas, 12 Hopeman Lane, Bella Vista, AR, 72715, US

(21) Appl. No.: 12/334,699

(22) Filed: Dec. 15, 2008

Related U.S. Application Data
(60) Provisional application No. 61/014,058, filed on Dec. 16, 2007.

(51) Int. Cl. B63C 11/02; G10K 15/00

(52) U.S. Cl. 405/185; 116/26

(57) ABSTRACT

A handheld multi-purpose device and methods used for communication, stabilization, position control, self-defense and environmental protection while in, or under, water. Said multi-purpose device is comprised of a rod approximately 24″ in length, a handle shaped into one end of the rod, created by bending the rod into two loops one-on-top of the other, leaving approximately 12″ of the rod straight from the handle, and two end caps, one glued on each end of the rod.

### CROSS-REFERENCE TO RELATED APPLICATIONS

This application claims the benefit of provisional patent application Ser. No. 61/014,058, filed 2007 Dec. 16 by the present inventor.

### FEDERALLY SPONSORED RESEARCH

Not Applicable

### SEQUENCE LISTING OR PROGRAM

Not Applicable

### BACKGROUND OF THE INVENTION

1. Field

This application generally relates to handheld devices used while in, or under, water. Specifically to a multipurpose handheld device and methods which can be used for communication, stabilization, position control, self-defense and environmental protection. This device is simple in design and use, powered solely by the user, is compact in design, and has no moving parts.

2. Prior Art

Historically snorkelers and SCUBA divers have had a difficult time finding easy to use multipurpose tools, or devices, to make snorkeling and/or diving safer and more enjoyable. Communicating with others, stabilizing descent/assent on a mooring line, controlling position in relation to objects, protecting the environment from accidental impact and even self-defense can be difficult and require the use of complicated, expensive, or multiple tools and user skills. Conventional underwater devices have several deficiencies which discourage most snorkelers and SCUBA divers from using them, and therefore, have not found wide approval and use.

Devices have been invented for single use such as the emergency underwater notification device on patent Ser. No. 10/979,519 filed 2004 Nov. 2. This device is complicated, is composed of multiple pieces, and is used only for emergencies. It cannot be used to signal, or communicate, with other divers in non-emergency situations.

Other devices exist than can be used help divers stabilize descent/assent on mooring lines, such as carbineer clips and dive gloves. Carbineer clips tend to be awkward and hard to use. Dive gloves are very useful but are outlawed in some dive sites around the world.

It is the Divers credo not to impact the environment, ‘touch nothing’ is the motto. In some locations is it very difficult to maintain position, or distance from objects, due to skill level or water current. Touching is sometimes necessary for safety; a device that allows the diver to stabilize with minimal impact because of its compact design would surely be welcomed.

A significant problem with most conventional underwater devices is that they have multiple components, or require equipment alterations, thereby being open to equipment or component failures. Modification of diving gear, or diving components, is time consuming, can be expensive, and require technical expertise. Seasoned divers understand the risk associated with their hobby, or profession, and demand reliability from their equipment, therefore devices that do not require gear modification would surely be preferred.

Another drawback of most conventional underwater devices is that they require maintenance for reliable performance. Much effort and expense can be saved with a device that requires no maintenance.

Yet another drawback is that most underwater devices are single use, or single purpose, in nature. Thus requiring a diver to carry multiple devices and learn multiple skills in order to use each device. For convenience, efficiency, and safety a diver would certainly prefer one device with multiple uses.

Another shortfall of many conventional underwater devices is that they require the user to press, or move, a button or switch in order to perform the operation. This can be difficult underwater. In many cases divers will be wearing SCUBA gloves in order to protect themselves and the environment, as well as for warmth. The gloves do help with protection but also reduce dexterity, thus making it difficult to press buttons or move switches. With this in mind, divers would likely prefer a device that has no buttons or switches to fumble with.

Yet another disadvantage to some conventional underwater devices is that they require the use of both hands to operate. For example, a device with this design might require that the operator hold the device in one had while using the other hand to make adjustments, or push a button. Divers would likely prefer a device that keeps one hand free to swim, or perform other tasks, using only one had to operate the device.

Another disadvantage of many conventional underwater devices is their complexity. Some are so complex that the user would need to practice using the device in order to be proficient in its use. An underwater device that is so simple in use that it can be immediately utilized by a diver of any age, or skill level, would certainly be preferred.

Still another major drawback of many conventional underwater devices is that they require an artificial energy source in order to function. Some require batteries; others require the use of pressurized air. Devices that require power from any artificial source is subject to performance issues as the result of power failures. A device that is solely powered by the user would certainly be preferred.

In summary, existing underwater devices suffer from one or more of these disadvantages:

(a) are fashioned of multiple moving components that, accordingly, have multiple components that can fail;
(b) require maintenance to uphold a specified level of performance and operational reliability;
(c) require buttons, switches, or other activation apparatus to be manipulated;
(d) require the use of two hands to operate;
(e) require practice to achieve proficient use;
(f) require the modification of SCUBA gear in order to function; and
(g) require an artificial energy source to function.

### OBJECTS AND ADVANTAGES

The present device overcomes the stated disadvantages of prior devices and offers significant advantages and uses. Accordingly, several objects and advantages of my device are:

(a) to provide an underwater multipurpose device which can function with no moving parts other than the users movement;
(b) to provide an underwater multipurpose device that is maintenance free;
(c) to provide an underwater multipurpose device that can be used equally well, with or without gloves;
(d) to provide an underwater multipurpose device that can be operated with one hand;
(e) to provide an underwater multipurpose device that can be immediately useful by a diver of any age, physical capability, or skill;
(f) to provide an underwater multipurpose device that can operate without the modification of SCUBA gear;
(g) to provide an underwater multipurpose device that can operate without the use of batteries, air pressure, or any other artificial energy source; and
(h) to provide an underwater multipurpose device that can offer multiple modes of operation.

Additional objects and advantages of my device will be present in the following description and the accompanying drawings.

### SUMMARY

A handheld multi-purpose device and methods used for communication, stabilization, position control, self-defense and environmental protection while in, or under, water. Said multi-purpose device is comprised of a rod approximately 24″ in length, a handle shaped into one end of the rod, created by bending the rod into two loops one-on-top of the other, leaving approximately 12″ of the rod straight from the handle, and two end caps, one glued onto each end of the rod. The length of the rod can vary depending user's preference and height.

### DRAWINGS-FIGURES

FIG. 1 is a view of the device manufactured for a right-handed user

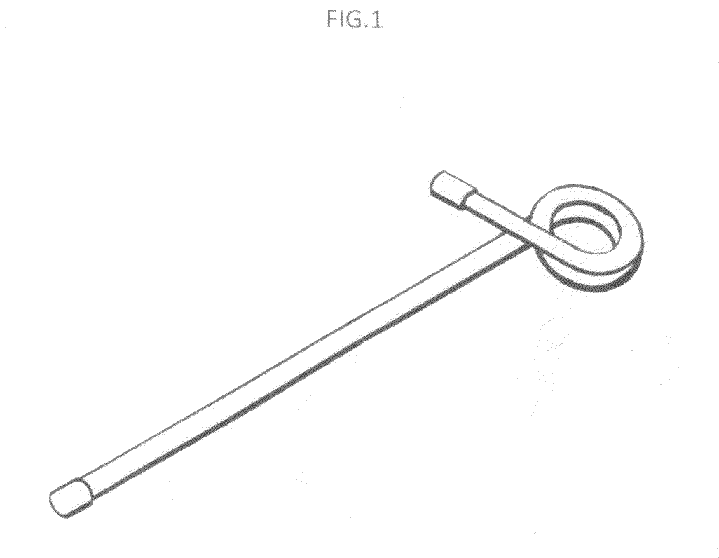

FIG. 2 is a view of the device manufactured for a left-handed user

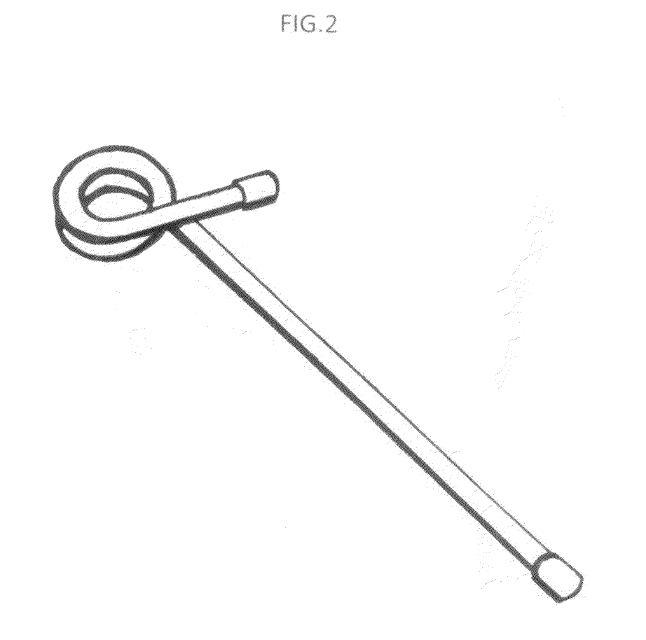

FIG. 3 is an exploded view of the device, showing the simplicity of only 3 parts

FIG. 4 is a view of the device as it would be held by a right-handed user

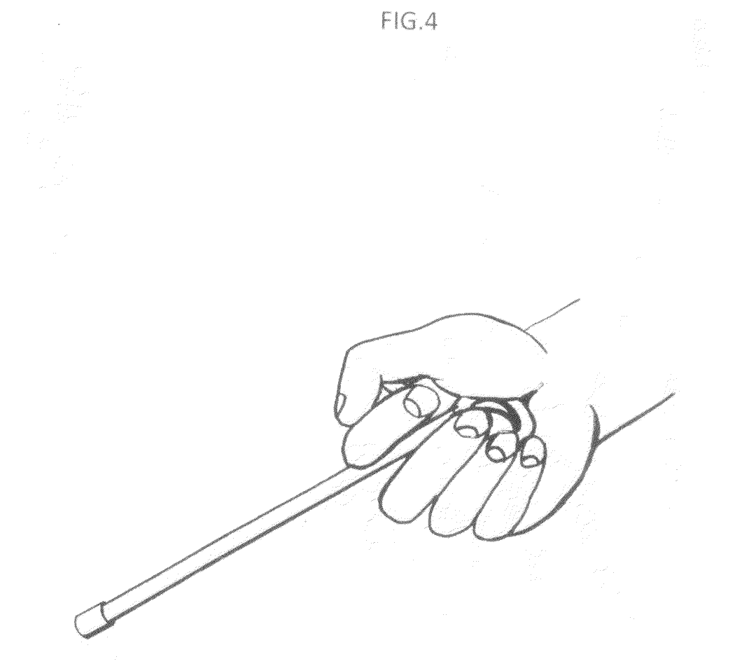

FIG. 5 is a view of a SCUBA diver using the device to control descent down a mooring line

FIG. 6 is a view of a SCUBA diver using the device to stabilize his position in a current

FIG. 7 is a view of a SCUBA diver using the device in a self-defense posture against an aggressive predator

FIG. 8 is a view of a SCUBA diver using the device to hold and/or control his distance from an object

FIG. 9 is a view of a SCUBA diver using the device to create noise in order to communicate with other divers

### DETAILED DESCRIPTION OF THE PREFERRED EMBODIMENTS

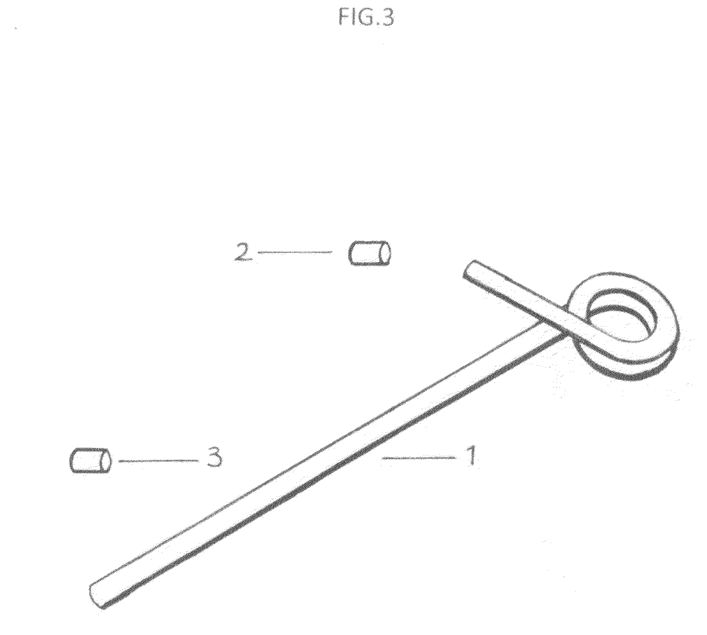

A typical embodiment of the multipurpose device is illustrated in FIG. 3. The device is of solid aluminum rod with two end tips made of vinyl affixed to the ends of the rod with glue. This embodiment show the handle created for a right-handed user. In this embodiment, the aluminum rod is made of a 0.25-inch diameter, available from a variety of commercial sources. However, the rod could consist of other materials and other diameters that can withstand the water pressures associated with SCUBA diving, such as other metals, fiberglass, graphite, thermoplastic resin, and thermosetting resin.

The device can be manufactured for either right or left-handed users; the difference between the two lies in the direction that the handle wraps. This customization provides ergonomic comfort to the user. The device can be manufactured in multiple lengths. The goal of the various lengths is to allow a diver to choose a tool that is appropriate for his height. Appropriate length is important for diver comfort, because when the tool is not in use, it will typically be attached to the divers buoyancy-control device.

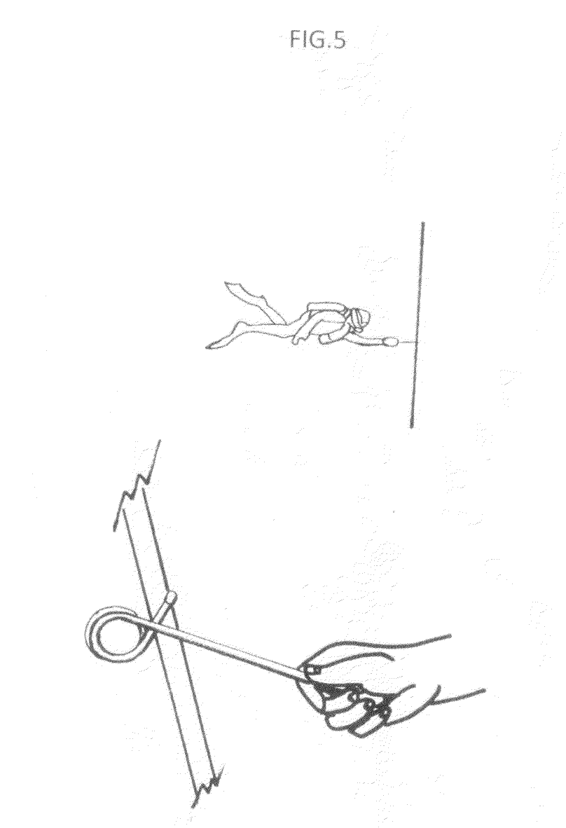

FIG. 5 shows a diver using the device to control descent down a mooring line; it can also be used to control assent in the same fashion. This helps protect ocean divers from unseen dangers such as, fire worms, bristle worms, stinging hydroids, or fire coral that may reside, or have settled, on the mooring lines. The tool may also be used in conjunction with the mooring line during decompression or safety stops, by allowing the diver to stabilize himself and thus maintain a particular depth. Most recreational divers practice a three minute stop at fifteen feet depth at the conclusion of every dive. This tool helps divers; especially beginners who may not have mastered their buoyancy-control skills maintain a uniform depth for the allotted time, without physically touching the line themselves.

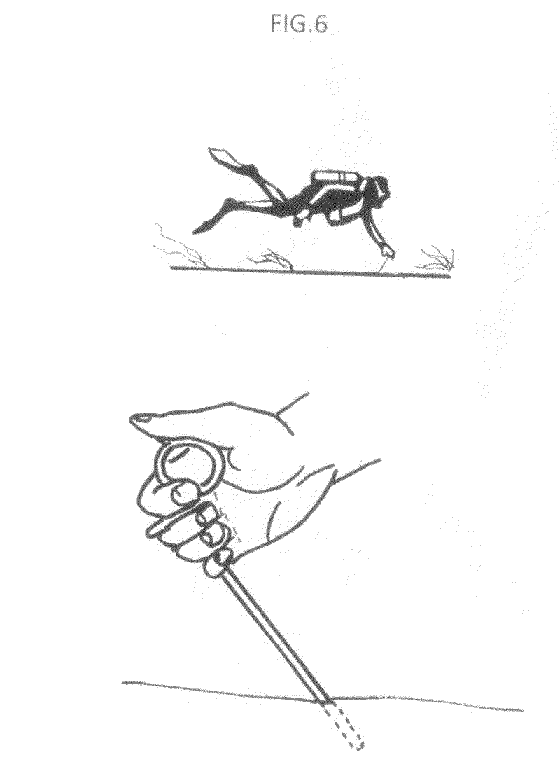

FIG. 6 depicts a diver using the device to secure his position in a current. By anchoring the device tip in a rock crevice, or sandy bottom, the diver can maintain his position without any/or much physical exertion, thus saving energy and reducing his air-consumption rate. Without the tool, the diver may try to anchor himself using his hand or swim fin possibly resulting in injury not only to the diver but also to the delicate coral reef, sponges, and other aquatic creatures.

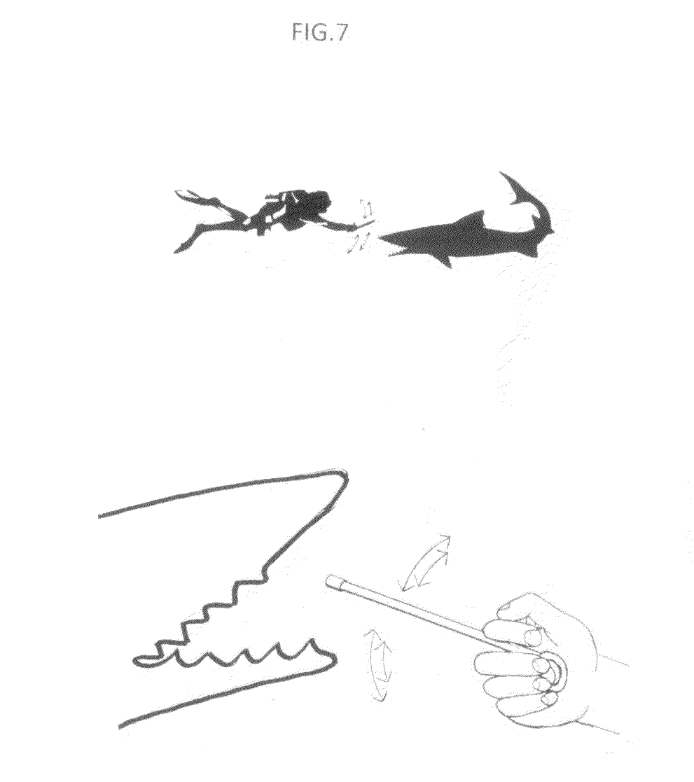

FIG. 7 illustrates a diver using the device to ward off an aggressive predator. As shown, waving the device may deter a potential aggressor. Alternately, the tool can be reversed to rap, or thump, the nose of an aggressive predator. As a last resort, it may be used as a weapon similar to a dive knife. Although it is rare for a diver to be harmed by marine life, it is comforting to know that the tool can provide some options to help defend against an attack. This tool should never be used to purposely harass or harm any person, animal, or plant; it is intended for self-defense.

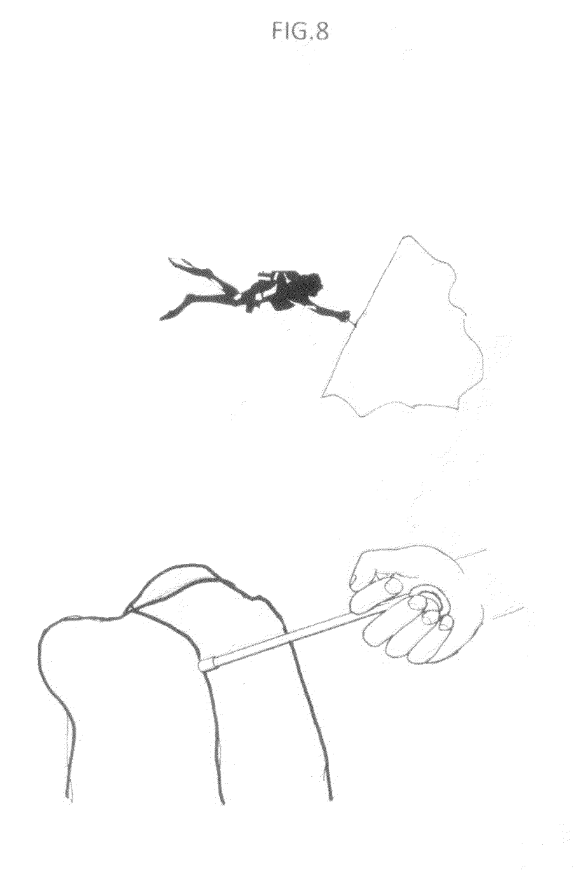

FIG. 8 demonstrates how the tool can be used to distance a diver from underwater hazards. Divers often penetrate sunken wrecks, caves, lava tubes and encounter razor-sharp rusting steel, sharp or delicate coral, and jagged rocks. Unforeseen forces such as currents, surges, waves, or inexperience may unexpectedly force an unsuspecting diver into these hazards. This tool allows a diver to “push away” from those hazards without using his hand, arm or leg, thus protecting the diver and the ecosystem.

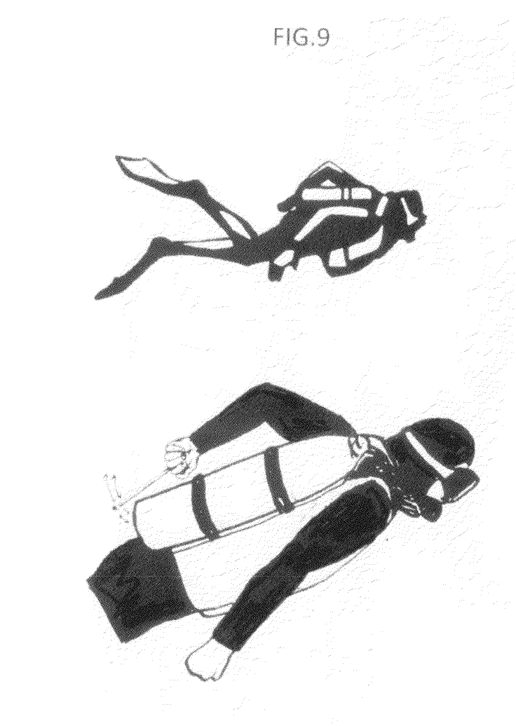

FIG. 9 shows a diver using the device to communicate to other divers by tapping the tool on his tank. Sound carries four times further in water than in air thus creates a loud metallic sound that carries well under water. As the diver taps harder, the volume increases. The volume and/or frequency of the tapping can convey a sense of urgency depending on the situation. This signaling capability can be used to simply point out interesting marine life and can prove to be invaluable during an emergency such as an equipment failure.

### CONCLUSION, RAMIFICATIONS, AND SCOPE

Accordingly, the reader will see that this multipurpose device is simple and effective and offers significant advantages over other designs.

Since the device is powered solely by a users wrist action the device's performance is very reliable. Because there are no moving pieces, or parts, to adjust or clean the device can be considered maintenance free.

The device requires only one hand to operate. Additionally, the device is equally easy to use, whether or not the user is wearing SCUBA gloves. In fact, the device is so easy to use; it is immediately useful by a diver of any age, physical capability, or skill. Operation of the device does not require any modification of any piece of SCUBA gear.

While the above description contains much specificity, these should not be construed as limitations on the scope of any embodiment, but as exemplifications of the presently preferred embodiments thereof. Many other ramification and variations are possible within the teachings of the various embodiments. For example, the current version of the tool is made of aluminum with vinyl tips. There are however many other materials that could be substituted to achieve the same or similar results. In addition to alternative materials, other design modifications could be implemented without changing its core functionality or design. Those mutations might include:

a) changing the shape of the handle

b) altering the length or shape of the shaft

c) adding a hook to either end

d) adding color or texture to the tool

e) varying the shape, style and color of the tips

f) varying the thickness of the rod

g) adding a optional wrist loop, strap, or clip

I claim:

1. A handheld multi-purpose device and methods used for communication, stabilization, position control, self-defense and environmental protection while in, or under, water. Said multi-purpose device is comprised of:
a. A rod approximately 24″ in length
b. a handle shaped into one end of the rod, created by bending the rod into two loops one-on-top of the other, leaving approximately 12″ of the rod straight from the handle,
c. and two end caps, one affixed on each end of the rod.

2. The hand-held multi-purpose device of claim 1 wherein said rod is made of 0.25 inch solid aluminum.

3. The hand-held multi-purpose device of claim 1 wherein said end caps are made of vinyl.

4. The hand-held multi-purpose device of claim 1 wherein said vinyl end caps are secured to the rod with glue.

5. The hand-held multi-purpose device of claim 1 wherein said end caps, rod, and handle are a one-piece unit.

6. A method of communicating underwater with said multi-purpose device, the method of communicating comprising of the steps of:
a. Grasping the device by the handle, and
b. tapping against oxygen tank producing a sound that is readily propagated through water.

7. A method of controlling descent down a mooring line with said multi-purpose device, the method of descent comprising of the steps of:
a. Grasping the device by the tip, and
b. hooking the mooring line with the handle,
c. pulling on the device to apply pressure on the line with the handle,
d. thus, controlling the rate of descent.

8. A method of stabilizing position in a current with said multi-purpose device, the method of controlling position comprising of the steps of:
a. Grasping the device by the handle, and
b. placing end tip into sea floor, or against an object,
c. allow the current to apply pressure against the sea floor, or object with the rod to hold position.

9. A method of defending against an aggressive creature with said multi-purpose device, the method of self-defense comprising of the steps of:
a. Grasping the device by the handle, and
b. moving the device back and forth in front of the aggressor,
c. using this defensive posture to warn aggressors away.
